(19) United States
(12) Patent Application Publication
(10) Pub. No.: US 2022/0273126 A1
(43) Pub. Date: Sep. 1, 2022

(54) INTERACTIVE VALET

(71) Applicant: Heida L. Thurlow, Houston, TX (US)

(72) Inventor: Heida L. Thurlow, Houston, TX (US)

(21) Appl. No.: 17/186,647

(22) Filed: Feb. 26, 2021

(51) Int. Cl. A47G 25/14; G09B 19/00; G08B 7/06

(52) U.S. Cl. CPC A47G 25/14; G09B 19/00; G08B 7/06

(57) ABSTRACT

An interactive valet having a frame to support hangers to receive and support garments such as, for example, a trouser hanger, a coat hanger, a tray and a hamper support. Load cells coupled to one or more of these supporting structures detect the deposit of an article thereon and generate one or more signals to a processor. The processor, in response to receiving a signal from a load cell or from a plurality of load cells, generates a response signal to a response device thereby causing the response device to produce an audible response, a visual response, or a combination thereof. The processor may be programmable to generate response signals that are customized to the load cell or plurality of load cells that detect the deposit of an article on a structure of the interactive valet, or customized to the user, or both.

### BACKGROUND

### Field of the Invention

The present invention relates to a valet for receiving and supporting articles of clothing. More specifically, the present invention relates to an interactive valet that senses the deposit of an article of clothing thereon and generates a responsive acknowledgement to the user to encourage repeat behavior.

### Background of the Related Art

A valet is a device, such as a rack, for holding clothing. Valets are often fitted with components such as, but not limited to, horizontal rods or bars for supporting garments such as folded trousers, shoulder mounts for supporting a coat or shirt, or other components for supporting garments thereon. A valet may be fitted with a hamper or receptacle for receiving socks or other garments, and the hamper or receptacle may be supported from a component of the valet.

### BRIEF SUMMARY

One embodiment of the interactive valet of the present invention include a frame that supports one or more structures for receiving and supporting a garment thereon, a sensor coupled to the interactive valet to detect the deposit of a garment on one of the support structures of the interactive valet and to generate a signal, a processor to receive the signal generated by the valet and to generate a signal and an output device to receive the signal from the processor and to generate one of an audible and a visual display to a user. In one embodiment of the interactive valet of the present invention, the sensor comprises a optical sensor wherein the optical sensor detects the absence of light as a result of light being blocked from reaching the sensor by the deposit of a garment on the valet. In another embodiment of the interactive valet of the present invention, the sensor is a load sensor wherein the load sensor detects the weight of a garment deposited on the valet. In one embodiment of the interactive valet of the present invention, the response device is a speaker that generates an audible acknowledgement of the deposit of the garment on the valet that can be heard by the user. In one embodiment of the interactive valet of the present invention, the response device is one of a liquid crystal display screen, a light emitting diode screen and a plasma display screen.

Embodiments of the interactive valet of the present invention may include a variety of supports for supporting garments thereon. For example, but not by way of limitation, the interactive valet may include a trouser hanger for supporting folded slacks wherein the load sensor is disposed intermediate the trouser hanger and an adjacent supporting member. In another embodiment, the interactive valet may include a coat hanger for supporting a sleeved garment such as a jacket, shirt or coat, wherein the load sensor is disposed intermediate the jacket hanger and an adjacent supporting member.

### BRIEF DESCRIPTION OF THE SEVERAL VIEWS OF THE DRAWINGS

FIG. 1 is a perspective view of an embodiment of an interactive valet of the present invention.

FIG. 2 is an illustration of the interaction between the one or more sensors and the one or more processors and the one or more output devices of an embodiment of the interactive valet of the present invention.

### DETAILED DESCRIPTION

One embodiment of the present invention includes one or more sensors coupled to a valet for receiving and supporting articles of clothing thereon. The articles of clothing may include trousers, shirts, coats, sweaters, shorts, sweatpants, socks, hats, shoes, and other articles that can be conveniently supported by a component of a valet. A valet may include one or more rods, especially one or more horizontal rods for supporting folded articles, or hooks for supporting articles, or shelves.

Embodiments of the interactive valet of the present invention include a sensor for detecting the deposit of an article of clothing to be supported by a component of the interactive valet and for generating a signal to a processor that is coupled to the valet. The processor is programmed to receive the signal from the sensor, and to generate an activation signal to an output device. The output device may be one or more of a visual display, such as an LED screen, LCD screen, or other readable output, or to an audible output device such as a speaker or a vibration generator similar to that used in connection with smart phones. One embodiment of the interactive valet of the present invention

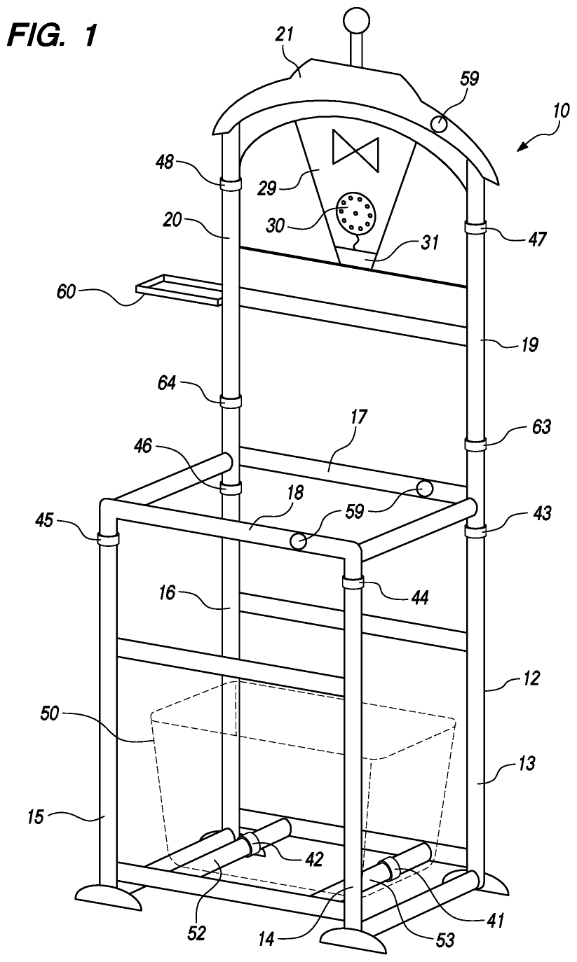

FIG. 1 is a perspective view of an embodiment of an interactive valet 10 of the present invention. The embodiment of the interactive valet 10 of FIG. 1 includes a trouser hanger 18 and a coat hanger 21, both supported on a frame 12 that includes legs 13, 14, 15 and 16. However, there may be one or any number of legs of the frame 12. The embodiment of the interactive valet 10 of FIG. 1 further includes a stabilizer 17 that may serve as a second trouser hanger. The coat hanger 21 of the embodiment of the interactive valet 10 of FIG. 1 is supported at an elevation above the level of the trouser hanger 18 by coat hanger supports 19 and 20.

The weight of the trouser hanger 18 (and of any articles supported thereon) is detectable by load cells 44 and/or 45. Alternately, a change in the weight on the trouser hanger 18 is detectable by load cells 44 and/or 45. When a pair of trousers (not shown) are deposited onto and supported by the trouser hanger 18, the load cells 44 and/or 45 detect the additional weight of the trousers and generate a signal corresponding to the weight or indicating the additional mass of the trousers. The signal from the load cell(s) 44 and/or 45 are transmitted, either wirelessly or by wires, to a processor 31 that, in response to the signal, generates a signal for an acknowledgement to the response device 30. The response device 30 may, in some embodiments, be a visual display such as, but not limited to, an LED or LCD display that can allow the user to see a picture, a figure, words, or some combination of these. Alternately, the response device 30 may, in some embodiments, be a speaker that produces an audible message that can be heard by the user. The response device 30 may be programmable to state or display a customizable message that may include the name of the user, or it may be programmable to play a song or music, including a song or score selected by the user.

The weight of the coat hanger 21 (and of any articles supported thereon) is detectable by load cells 63 and/or 64. Alternately, a change in the weight on the coat hanger 21 is detectable by load cells 63 and/or 64. When a coat or other article (not shown) is deposited onto and supported by the coat hanger 21, the load cells 63 and/or 64 detect the additional weight of the coat and generates a signal corresponding to the weight or indicating the additional mass of the coat. The signal from the load cell(s) 63 and/or 64 are transmitted, either wirelessly or by wires, to a processor 31 that, in response to the signal, generates a signal for an acknowledgement to the response device 30. Again, the response device 30 may, in some embodiments, be a visual display such as, but not limited to, an LED or LCD display that can allow the user to see a picture, a figure, words, or some combination of these. Alternately, the response device 30 may, in some embodiments, be a speaker that produces an audible message that can be heard by the user.

In one embodiment of the interactive valet 10 of the present invention, the audible response may be a pleasant acknowledgement of the responsibility of the user by saying, for example, “thank you,” “well done!” or “Atta Boy!.” Alternately, the audible response may be stated by the response device 30 in a foreign language. In this manner, the user may become familiar with frequently used expressions in a foreign language. In other embodiments, any of these statements may be spelled out on a display to be read by the user.

Alternately, an embodiment of the interactive valet 10 of the present invention may include a tray 60 for receiving keys, a wallet, a cell phone or other personal article that is often carried by a person and removed from a pocket upon disrobing. The tray 60 shown in FIG. 1 is supported on coat hanger support 20 but could be supported on any component of the interactive valet 10. One embodiment of the interactive valet 10 of the present invention may include an additional load cell 47 or 48 or an additional set of load cells 47 and 48 that enable the processor 31 to distinguish between the loading of the tray 60 as a result of an article being deposited thereon and the loading of the coat hanger 21. It will be understood that, with the structure and location of the load cells 47, 48, 43 and 44 shown in FIG. 1, the deposit of an article on the tray 60 will cause a signal or signals to be generated by one or both of the load cells 63 and/or 64 and sent to the processor 31, and the deposit of an article on the coat hanger 21 will cause a signal or signals to be generated by one or all four of the load cells 63, 64, 47 and 48 and be sent to the processor 31. In response, the processor 31 may be programmable to determine from the signals received whether an article was deposited on just the tray 60, on the coat hanger 21, or on both of these structures, and to generate a customized signal for that particular structure.

In one embodiment of the interactive valet 10 of the present invention, a hamper 50 (shown in dotted outline form) may be supported on hamper supports 52 and/or 53. These hamper supports 52 and/or 53 may include load cells 41 and/or 42, respectively, and these load supports may also be configured to generate a signal upon detecting that an article has been deposited in the hamper 50, and for then generating a signal to the processor 31 as described herein above.

An embodiment of the interactive valet 10 of the present invention may include one or more optical sensors 59 that is strategically positioned on the one or more trouser hangers 17 and/or 18 or on the coat hanger 21 to be covered by the deposit of a pair of trousers or a coat thereon. The optical sensor 59 responds to being covered by generating a signal to the processor 31 which then generates a response signal to the response device 30.

The response device 30 and/or the processor 31 may be housed within, or supported on, a panel 29 that is positioned on the interactive valet 10 at a height and location such that any audible response can be heard or any visual display may be easily seen.

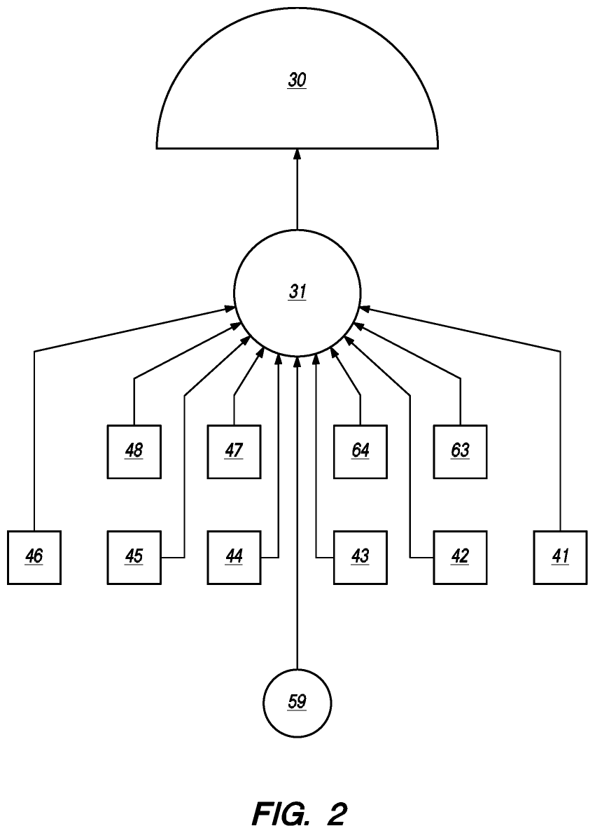

FIG. 2 is an illustration of the interaction between the one or more sensors and the one or more processors and the one or more output devices of an embodiment of the interactive valet of the present invention. FIG. 2 shows load cells 48, 47, 64, 63, 46, 45, 44, 43, 42 and 41 or of the optical sensor 59 configured to generate and deliver signals to the processor 31, and the processor configured to generate a responsive signal to the response device 30. It will be understood that the processor 31 may be programmable to generate a customized responsive signal for each of the load cells or, alternately, for any given combination of load cells.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

I claim:

1. An interactive valet, comprising:
a sensor coupled to the valet to detect the deposit of a garment on the valet and to generate a signal;
a processor to receive the signal generated by the valet and to generate a response signal; and
an response device to receive the signal from the processor and to generate one of an audible and a visual display to a user.

2. The interactive valet of claim 1, wherein the sensor is a light sensor; and
wherein the light sensor detects the absence of light as a result of light being blocked from reaching the sensor by the deposit of a garment on the valet.

3. The interactive valet of claim 1, wherein the sensor is a load sensor; and
wherein the load sensor detects the weight of a garment deposited on the valet.

4. The interactive valet of claim 1, wherein the response device is a speaker that generates an audible acknowledgement of the deposit of the garment on the interactive valet that can be heard by the user.

5. The interactive valet of claim 1, wherein the response device is one of a liquid crystal display screen, a light emitting diode screen and a plasma display screen.

6. The interactive valet of claim 3, further comprising:
a trouser hanger for supporting folded slacks; and
wherein the load sensor is disposed intermediate the trouser hanger and an adjacent supporting member.

7. The interactive valet of claim 1, further comprising:
a jacket hanger for supporting a sleeved garment; and
wherein the load sensor is disposed intermediate the coat hanger and an adjacent supporting member.

8. The interactive valet of claim 3, further comprising:
a trouser hanger for supporting folded slacks; and
wherein the light sensor is disposed proximal to the trouser hanger and an adjacent supporting member.

9. The interactive valet of claim 1, further comprising:
a coat hanger for supporting a sleeved garment; and
wherein the load sensor is disposed intermediate the coat hanger and an adjacent supporting member.
